(19) United States
(12) Patent Application Publication
(10) Pub. No.: US 2024/0025024 A1
(43) Pub. Date: Jan. 25, 2024

(54) CORDLESS ELECTRIC COIL ROOFING NAIL GUN APPARATUS

(71) Applicant: David Sosa, Elsa, TX (US)

(72) Inventor: David Sosa, Elsa, TX (US)

(21) Appl. No.: 17/872,609

(22) Filed: Jul. 25, 2022

(51) Int. Cl. B25C 1/06; B25C 1/00

(52) U.S. Cl. CPC B25C 1/06; B25C 1/008

(57) ABSTRACT

The present invention is directed to an improved electric coil roofing nail gun apparatus. The apparatus is as compact as possible and has a nail coil cartridge with a quick release mechanism. The apparatus has numerous safety features including a retractable safety strap attachable to the user to prevent dropping the apparatus from height when used as a fastener for roofing nails. The apparatus includes a battery pack compartment which has an attachment member allowing the apparatus to be hung from a tool belt or ladder. The apparatus is made from lightweight, high strength plastics wherever possible to reduce weight.

### BACKGROUND OF THE INVENTION

### 1. Field of the Invention

The present invention relates to nail guns. More specifically, the invention relates to a cordless coil roofing electric nail gun for driving fasteners such as nails with several safety and convenience features.

### 2. Description of the Prior Art

U.S. Pat. No. 3,552,627 issued on Jan. 5, 1971, to Angel Moreno describes a pistol shaped electrically operated hammer and nail driver in which nails are fed from a horizontal side magazine and driven forward by a horizontally aligned hammer.

U.S. Pat. No. 5,653,371 issued on Aug. 5, 1997, to Chang Feng-Mei Hou describes a longitudinally aligned magazine for a power nail gun positioned parallel to the handle and comprising a case for holding a bar of T-shaped nails and pushing forward with a follower plate connected to two compression springs.

While both devices are generally effective they suffer from safety and convenience issues. Regarding safety issues, it is well known that nailing guns are used in both framing and roofing which means users will often be elevated relative to the ground as well as other workers or passers by. Accordingly, it would be useful to provide a means to prevent dropping the tool as this could cause injury to persons or objects below. Also, the user himself may fall attempting to secure a slipping nail gun which is a relatively heavy piece of hardware.

Regarding convenience issues, some nail guns have complicated feed and nail holder (cartridge or magazine) release mechanisms which can make reloading difficult and time consuming. Electric nail guns in particular are known for having very complicated feed and release mechanisms as the designs are focused on conserving power, which requires sophisticated means to reduce the energy needed to position and drive the nails or other fasteners. Accordingly, it would be useful to provide a nail gun with a simple cartridge and release mechanism for the cartridge.

The present invention is directed to an improved cordless electric coil roofing nail gun apparatus. The apparatus is as compact as possible and has a nail coil cartridge with a quick release mechanism. The apparatus has numerous safety features including a retractable safety strap attachable to the user to prevent dropping the apparatus from height when used as a fastener for roofing nails. The apparatus includes a battery pack compartment which has an attachment member allowing the apparatus to be hung from a tool belt or ladder. The apparatus is made from lightweight, high strength plastics wherever possible to reduce weight. Lighting is provided to allow for operation in low light conditions.

### SUMMARY OF THE INVENTION

It is a major object of the invention to provide an improved fastening apparatus.

It is another object of the invention to provide an improved cordless electric coil roofing nail gun apparatus with enhanced safety and convenience features.

It is another object of the invention to provide an improved electric coil roofing nail gun apparatus that can be tethered to the user.

It is another object of the invention to provide an improved electric coil roofing nail gun apparatus with a retractable tether.

It is another object of the invention to provide an improved electric coil roofing nail gun apparatus with an easily detachable nail coil cartridge.

It is another object of the invention to provide an improved electric coil roofing nail gun apparatus with an attachment means for attaching to a horizontal support.

It is another object of the invention to provide an improved electric coil roofing nail gun apparatus made of lightweight high strength materials to reduce weight.

It is another object of the invention to provide an improved electric nail gun apparatus having illumination means to allow for operation in low light conditions.

### BRIEF DESCRIPTION OF THE DRAWINGS

Various other objects, features, and attendant advantages of the present invention will become more fully appreciated as the same becomes better understood when considered with the accompanying drawings, in which like reference characters designate the same or similar parts throughout the several views, and wherein:

FIG. 1 shows a perspective view of the nailgun apparatus of the invention.

### DETAILED DESCRIPTION OF THE PREFERRED EMBODIMENTS

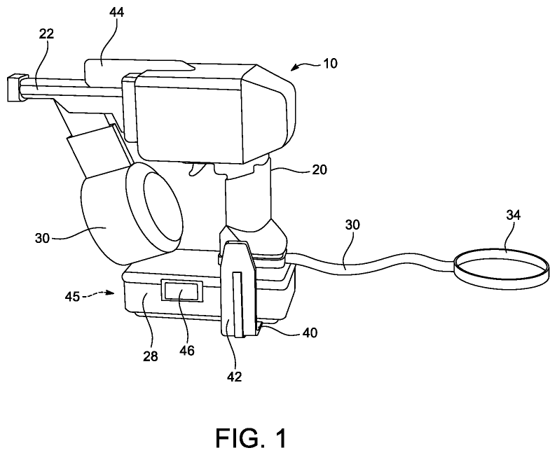

Referring now to FIG. 1, the apparatus, generally indicated by the numeral 10 is shown. The apparatus 10 is formed generally in the shape of a hand gun having a handle section 20 and a barrel section 22. A battery compartment 26 extends generally downwardly from the handle section 20, the compartment including electrical contacts and means for physically securing the battery 28. A coil nail cartridge 30 is removably attached between the barrel section 22 and the handle section, the cartridge 30 holding a quantity of fasteners such as nails in the well known manner, the nails ejectable from the barrel 22 via an internal electromagnetic hammer mechanism. The cartridge 30 is of the quick disconnect type so that they can be interchanged or replaced easily. The casing of the gun apparatus 10 may be cast from a strong, lightweight metal such as aluminum, magnesium, or alloys thereof, but is preferably made of a carbon fibre or other non-metallic strong rigid material. Even if the main casing or housing for the handle section 20 is made of metal, non critical parts such as the battery compartment 26 are made of lightweight non-metallic materials to reduce weight and vibration. Of course, the barrel 22, and the moving members such as hammer lever, hammer, etc., and the nail tracks should be of a more durable and wear-resisting material such as for example a steel alloy.

Automatic fasteners such as coil roofing nail guns are typically used for roofing and framing construction, accordingly, workers are often elevated relative to ground level. This creates a dangerous falling tool hazard as the tools are generally very compact and heavy, capable of causing great bodily injury or even death. Accordingly, means should be provided to reduce or eliminate or reduce the possibility of the nail gun apparatus falling.

A strap 30 is attached to the handle section 20. The free end 32 of the strap is formed of an adjustable size loop 34. The loop 34 can be adjusted to be attached about the user, with the strap 30 preferably adjustable to fit users of varying sizes. Preferably, the strap 30 is retractable via a spring loaded reel or winding mechanism, which is biased for retraction so that the user does not have to manually retract or otherwise secure the strap 34.

In addition to strap 34, an attachment member 40 extends from the bottom of the casing 20. The attachment member 40 has an arm 42 adjacent to the battery compartment 28, the arm formed in a right angle and sized for looping about a horizontal support member such as a ladder rung. The arm 42 may also be useful as a “catch” to prevent or at least reduce the velocity of the apparatus should the user lose control, as the apparatus 10 may be slowed by the arm 42 hitting shingles, gutters, etc.

The battery compartment 28 contains a battery 45 which is the sole source of operating power for the apparatus 10. Thus, the apparatus 10 is cordless, obviating the need for an electrical cord which reduces the possibility of injury from tripping, electrical shock, or other hazards associated with a 100 foot long power cord. A quick release mechanism includes a quick release button 46 which in one depression releases the battery 45 to allow for a rapid exchange of batteries while in the field.

An illumination means such as an LED 44 is positioned to illuminate the area being worked by the nail gun. The LED 44 produces a focused illumination pattern to ensure sufficient light to operate the apparatus in low light conditions.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the sole embodiment described above, but encompasses any and all embodiments within the scope of the following claims:

1. An electric coil roofing nail gun apparatus comprising:
a casing having a handle portion, a coil nail cartridge, and a forward nail discharge portion, wherein said handle portion comprises a battery compartment;
a strap retractably contained within said handle portion, wherein said strap has a free end that can be adjustably about a user, wherein said strap is attachable to the user to prevent dropping said apparatus from height; and
an attachment arm for positioning on a horizontal support, wherein said attachment arm is configured in a right angle to said horizontal support and extending from said battery compartment.

2. (canceled)

3. The apparatus of claim 1 wherein said horizontal support is a ladder rung.

4. The apparatus of claim 1 wherein said battery compartment contains a battery, and wherein said compartment is configured for quick release of said battery.

5. The apparatus of claim 4 wherein said battery is the only source of operating power.
